(19) United States
(12) Patent Application Publication
(10) Pub. No.: US 2022/0136665 A1
(43) Pub. Date: May 5, 2022

(54) STRUCTURAL ARRANGEMENT APPLIED TO A LAMP FOR USE IN EXTREME LOW- AND HIGH-TEMPERATURE ENVIRONMENTS

(71) Applicant: Rosangela LOPES ARGEMIRO, Balneário Camboriú-SC, CEP (BR)

(72) Inventor: PAULO FURLANETO FILHO, Seara (BR)

(21) Appl. No.: 17/599,801

(22) PCT Filed: May 12, 2020
(86) PCT No.: PCT/BR2020/050156

§ 371 Date: Sep. 29, 2021

(30) Foreign Application Priority Data
May 13, 2019 (BR) BR 20 2019 009751
Dec. 17, 2019 (BR) BR 20 2019 026946

(51) Int. Cl. F21S 4/28; F21K 9/272; F21V 31/00; F21V 5/04; F21V 23/06; F21V 21/088

(52) U.S. Cl. CPC F21S 4/28; F21K 9/272; F21V 31/005; F21Y 2115/10; F21V 23/06; F21V 21/088; F21V 5/04

(57) ABSTRACT

The invention relates to a structural arrangement applied to a lamp for use in extreme low- and high-temperature environments, in which this LED lamp has a fully sealed structure and further overcomes the problem of exclusively obtaining specific lighting colorimetric patterns. The structure of the lamp is designed to provide protection level IP69K. The structure generally comprises the lens (110) fastened and glued to the body, the LED light emitter, LED ribbons and heads, which are also fastened and glued to the body which is already joined and fastened to the lens. The glue used is specific and the structure is designed to provide an enhanced seal. The specific strip is arranged between the lens and the LED wire such as to cover the entire lens region on the inside thereof.

This patent document refers to a configuration applied to a led lamp, for using in extreme environments, especially at low temperatures and at high temperatures and high humidity.

### BACKGROUND OF THE INVENTION

A problem found in ultra-low temperature closed environments, such as cold chambers, cold storages, for example, is the high condensation of indoor air due to ultra-low temperatures, as consequence, lamps used in this environment, have low useful life, due to the aggressive environment in which they are found. Another problem presented in these same environments is that some specific colorimetric lighting standards are necessary, due requirements from regulatory agencies.

In prior of art there are some constructions for lamps, including for using in low-temperature environments. However, the constructive configurations of lamps already known on market, do not have a compatible watertightness to avoid their total protection in these types of more severe environments.

In special, can be cited some patent documents such as US20050069765, for example, which describes a waterproof lamp and comprises the low temperature resistant light emitting device; however, its constructive disposition is totally different from that which will be presented in this document, and, due to the constructive way in which it is presented, it does not guarantee the tightness that the new disposition, object of this document, proposes.

Document WO2010137171 also describes a lighting device with a compatible constructive arrangement for use in a cold place, for example, at a temperature below zero.

Document KR101407621 shows a lighting device whose construction is compatible to allow its operation in low temperature environments.

Document EP0641968 also describes a constructive arrangement for a lamp that is especially intended for environments with low temperatures; this arrangement is for fluorescent lamp. Documents DE4012588 and U.S. Pat. No. 3,309,565 also describe construction of a lamp, for use with fluorescent lamp, to work in low temperature environments.

Another problem related to led lamp for harsh environments, such as low temperatures, is that entry of moisture inside the lamp driver (its led light emitting device), increases the risks of closing short circuits and damage the equipment (lamps), and may even cause further damage.

Another important point is that said led lamp was designed to be used in environments such as cold chambers, and this kind of environment sometimes requires some specific colorimetric standards, including required for regulatory agencies, and a simple solution has yet been found such as presented here in this document.

That way, the constructive arrangement of this specific led lamp, respecting tightness standards, ensures specificity in its application. In addition, in the lighting function, there are cases in which it is necessary to obtain lighting in specific colors, pre-established for the purpose to which it applies. And this specific color, pre-established, also needs to respect certain colorimetric standards.

What is normally done and known in the current state of the art, when it is necessary to reach a certain lighting color, in led lamps, is to replace the led strip with the conventional color, with a LED tape with the desired color. However, with this type of adjustment, in addition to making the process more expensive, it is restricted to the available colors of the led, and there are still certain colorimetric standards required that cannot be achieved with this type of adjustment.

Another solution, also known in the state of the art, to satisfy this need for color matching, is to make the lens of the led with the color of interest. However, for this case, there would be greater problems with the manufacture of lenses, greater controls of their production, of their stock, a problem related to the replacement of lenses, as well as a series of other inconveniences, as the logistics, for example.

Despite the foregoing, none of them has a constructive configuration for led lamps for use in harsh environments, especially in ultra-low temperatures, and with high humidity, being able to withstand temperatures up to −40° C., which solves all the problems mentioned as the case tightness, and colorimetric variation, as presented in this document.

The subject of this patent is a constructive configuration to a led lamp, completely watertight and still providing a considerable useful life; and, in addition, it presents a specific arrangement in the way of varying the color of its lighting, for pre-established colors respecting certain colorimetric patterns without the need to change the led, or its led board, or the lenses of the lamp.

In order to solve the problems related to tightness, the entire construction of the lamp, object of this document, was developed to achieve an IP69K degree of protection.

The degree of protection IP69K is an IP (Ingress Protection) classification system published by the IEC (International Electrotechnical Commission) and classifies the degree of protection that a housing offers against solid and liquid objects, to operate a closed electrical equipment. It is currently the highest degree of security, indispensable in devices that have electronics and that will be used in extreme environments in the food and chemical industries. In particular, devices with degree of protection IP69K are developed for areas where extra protection is needed, like areas with high pressure, and/or with extreme temperatures (low or high) and/or with high humidity.

As a way to solve the problem of colorimetric variation, without having to replace leds and without the need to manufacture lenses in different colors or replace led boards, we considered the possibility of including a sheet of translucent polymeric material in the color of interest. This solution good, however it does not reach some required colorimetric standards. However, after a series of tests, an ideal arrangement was reached, which is also part of this patent document; it was developed a specific film. In this case, this specific film is added between the lens and the led, in order to cover the entire internal surface of the lens, through the internal part of the led lamp in question.

The configuration of the led lamp, subject of this patent, has the following characteristics: it is assembled in an environment with controlled relative air humidity (RAH), it is constructed in order to guarantee high watertightness and with materials that withstand extreme temperatures from −40° C. to 80° C.; such a construction is comprised by the lens, preferably in polycarbonate, and can be presented in different colors, preferably a milky color, to avoid visual distortion and glare, joined to a body, preferably made of aluminum; internally the body has a constructive configuration in order to provide the led emitter device. At each end of the lamp there is an end cover, and on one side we will call it simple end cover and the opposite we will call it the energized end cover, as the latter will comprise a cable gland where the led emitter device will be connected allowing your connection to a power source.

The lamp, object of the present document has characteristics in its construction that provides a constructive differential, resulting in functional improvement in its use application, especially in extreme temperatures with regard to tightness, as well as in obtaining pre-established colors respecting standards specific colors.

One characteristic of this lamp, is to have a completely hermetic construction; contains cable glands as part of its construction, compatible with the construction of the lamp maintaining its airtight feature; and as previously informed, the assembly of the said lamp is carried out in a controlled environment.

Another characteristic of this lamp, is that its construction guarantees an IP69K degree of protection. Tightness and protection tests were carried out and it was proven that this constructive arrangement guarantees very high watertightness, does not allow dirt to enter the interior of the lamp, and because it is mounted in an environment with controlled IVR, it prevents internal condensation due to thermal exchange with the environment.

Another characteristic of its construction is the specific blade that is added between the lens and the led, to cover the entire internal surface of the lens, giving the pre-established color without the need to change the led or the lamp lens, or led boards, also improving its final application.

### DETAILED DESCRIPTION OF THE DRAWINGS

The following figures, by way of illustration, facilitate the understanding of the constructive arrangement of the lamp, matter of this patent document.

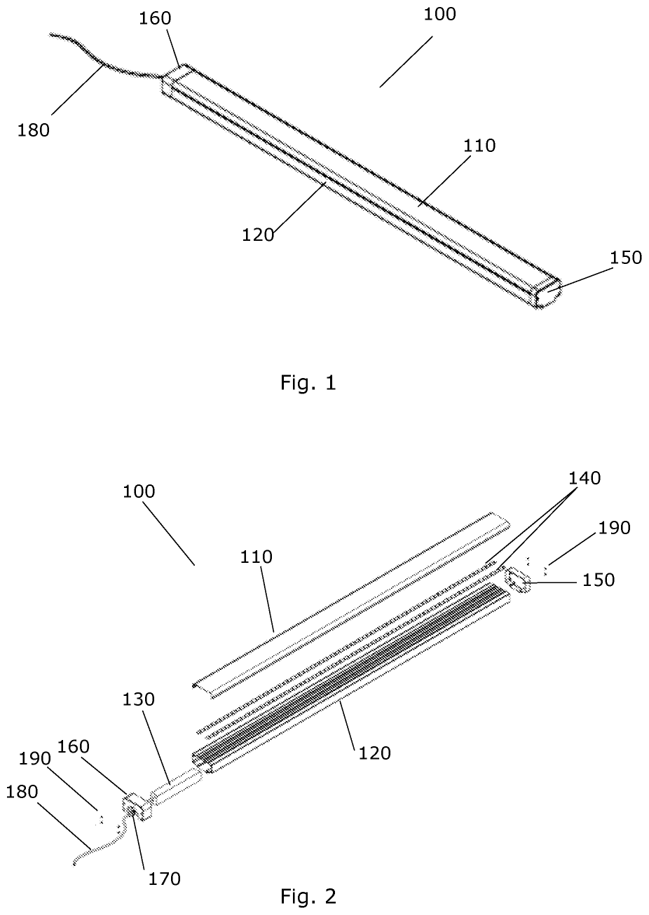

FIG. 1 shows in perspective a representative illustration of the lamp.

FIG. 2 shows a perspective illustration of an exploded view representative of the lamp.

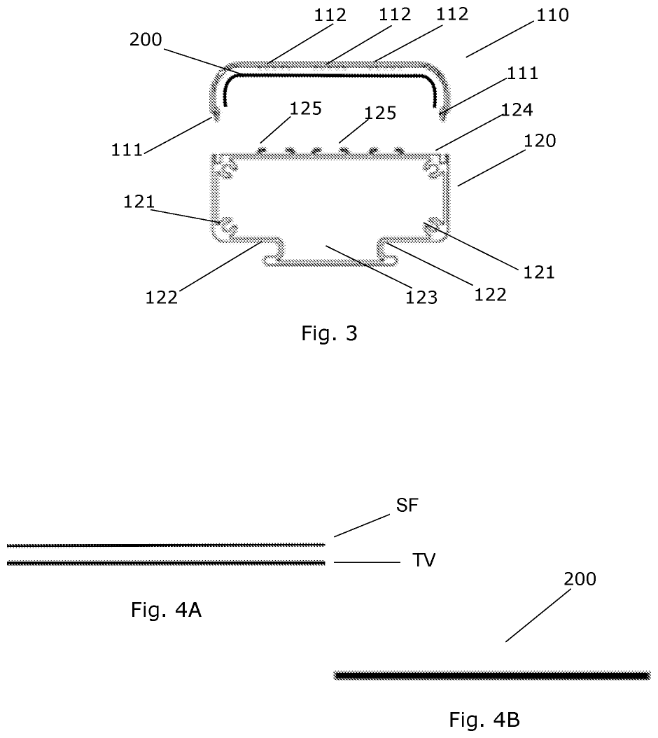

FIG. 3 shows an exploded view that illustrates the cross section of the body and the lens, parts of the lamp, and the position in that the specific film is inserted in, and how it is arranged in said led lamp.

FIGS. 4A and 4B show, illustratively, how the specific film is obtained.

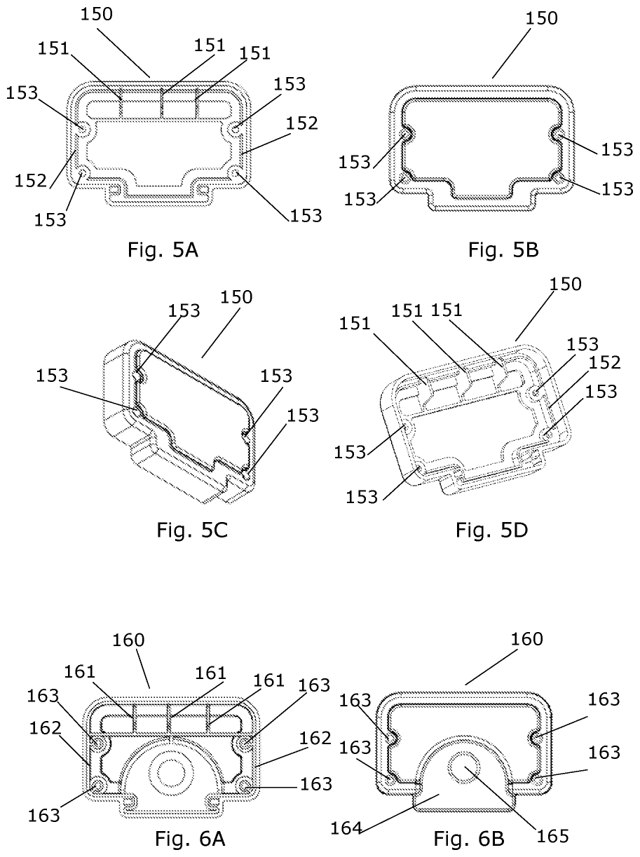

FIGS. 5A, 5B, 5C and 5D illustrate one of the end covers, here called the simple end cover, which is mounted at one end of the lamp body.

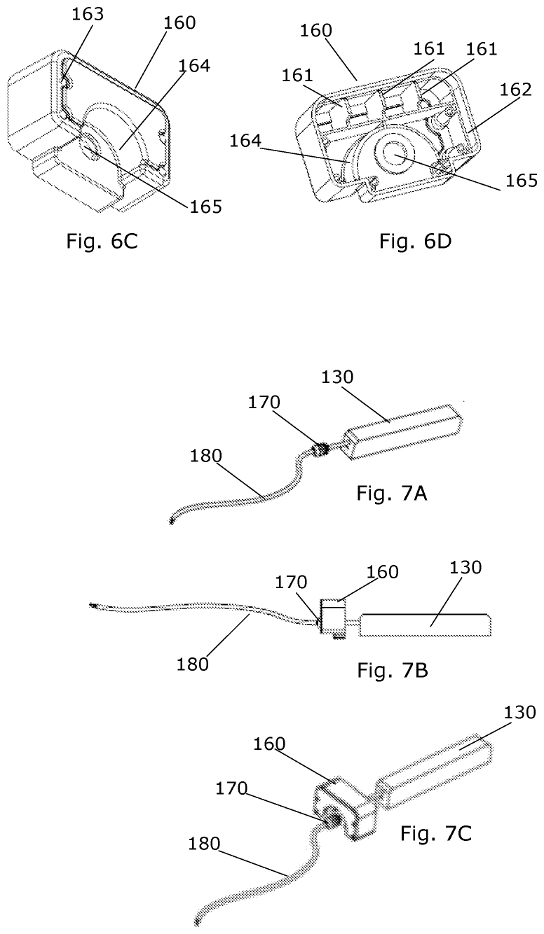

FIGS. 6A, 6B, 6C and 6D illustrate the other end cover, here called the energized end cover, which is mounted on one end of the lamp body, where the cable gland is positioned.

FIG. 7A shows the led light emitter device with the cable gland, and FIGS. 7B and 7C illustrate the energized end cover with the positioning of the cable gland and the led light emitter device.

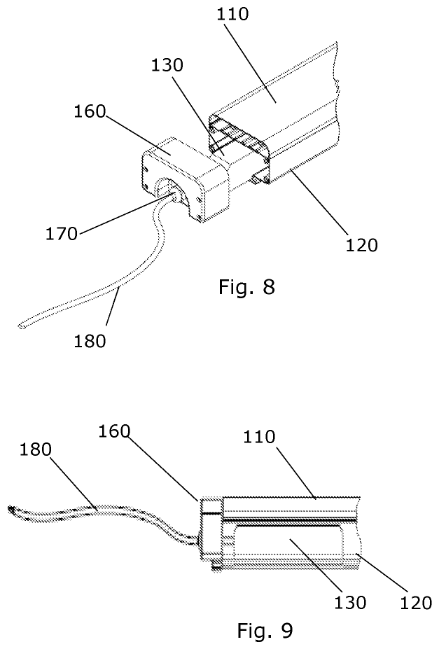

FIG. 8 shows, in a representative way, the end of the lamp that receives the energized end cover, to illustrate the assembly and arrangement of the led emitter device, internally to the lamp body.

FIG. 9 shows a side view that illustrates the end of the lamp that receives the energized end cover showing the interior of the body to also illustrate the internal layout of the led light emitter device.

### DETAILED DESCRIPTION OF THE INVENTION

In reference to the figures presented, according to FIGS. 1, 2 and 3, the constructive arrangement applied to a lamp (100) for use in extreme environments, especially at low temperatures, which is the object of this patent document, is assembled in an environment with controlled relative air humidity (RAH), has construction in order to guarantee high watertightness; such construction is generally understood by the lens (110), fixed and glued to the body (120), the led emitter device (130), the led tapes (140) and the end covers (150 and 160) also fixed and glued to the body (120) already joined and fixed with the lens (110). The lens (110) is preferably made of polycarbonate and can be presented in different colors, preferably a milky color, to avoid visual distortion and glare; said lens (110) provides edge (111) with compatible recess to be joined by fitting to the coupling channels (124), and also provides grooves (112) on the inner surface to facilitate flexion and elastic deformation at the time of its assembly to said body (120).

The body (120) is preferably made of aluminum; and internally the body (120) has configuration constructive in order to position and attach the led emitter device (130) and, of course, make available the respective led tapes (140). The end covers (150 and 160) is arranged at each end of the lamp, and one side we will call it of simple end cover (150) and the opposite we will call of energized end cover (160); in this latter will comprise a constructive way to receive a cable gland (170) where the led emitter device (130) will be connected allowing its connection to a power source, by means of a cable (180) conducting electric energy. Said end covers (150 and 160) are properly attached to the ends of the body (120) of the lamp (100) by a set of screws (190) and by internal gluing, made with specific glue. Just like the lens (110) is also properly attached to the body (120) by engagement, which is also glued with specific glue.

The specific glue used to attach the elements of lamp (100), such as the end covers (150 and 160) and the edges (111), is a special glue to ensure the correct attaching and tightness. This special glue should preferably be based on one-component PU, with good adhesion, elasticity, low odor, resistant to aging and with standing low temperatures, as well as corrosive environments.

Still with respect to FIG. 3, that shows in greater detail the lens (110) and the body (120) of the lamp (100). The lens (110) is preferably of polycarbonate, can have different colors, preferably milky, to avoid visual distortion and glare, and the body (120) of the lamp, in aluminum material; said body (120) providing screw points (121), preferably in each of the four corners of the inner part of said body (120), aligned concentrically to the respective screw holes of the end covers (which will be shown below). Said body (120), also has channels (122) in the region of its base, for hooking clamp/clamp to attach the lamp (100) at the place where it will be arranged to perform its function; this attachment can be done by means known as clamps, fixing clips or others, without compromising the inventive step of its construction. In the internal region of the base of the body (120) there is a recess (123) with dimensions sufficiently compatible to allocate and be properly fixed the led emitter device (130); in this way, the led emitter device (130) is positioned internally to the body (120), being properly attached at the end of said body (120) in this internal recess (123) of the base. A clamp can be used to ensure better fixation of the led emitter device (130) in the internal region of the recess (123) to the body (120).

In the region of the upper longitudinal edges, are provided channels (124), with compatible dimensions for the allocation of the specific glue and the fitting of the longitudinal edge (111) of the lens (110), so that the region be completely isolated and watertight. The upper part of the body (120) also provides a set of channels (125) for the arrangement of the led tapes (140) longitudinally to the body (120) of the lamp (100). The number of channels (125) may vary, depending on the number of led tapes (140) necessary in the lamp (100), without mischaracterize the inventive step of this document.

FIG. 3 already shows the arrangement of the specific film (200) internally to the lamp (100) between the lens (110) and the led tape (140).

FIGS. 4A and 4B show how the specific film (200) is obtained. This specific film (200), FIG. 4B, is obtained from joining, or bonding, by overlapping, the security film (SF), with a thickness in the range of 2000 to 4000 microns, to a polymeric material, especially the translucent vinyl (TV), flexible, as shown in FIG. 4A. Translucent vinyl (TV) may have different colors, especially in the primary colors, which are blue, red, yellow, but can be blue, green, orange, indigo and violet, among others resulting from the primary colors. The security film (SF) after properly glued to the translucent vinyl (TV) forms the specific film (200), flexible, as shown in FIG. 4B, which presents certain colorimetric standards to obtain lighting in some desired colors, with ease of manufacturing, maintenance, and assembly.

FIGS. 5A, 5B, 5C and 5D illustrate in more detail the simple end cover (150), which has compatible contour lines to fit the end of the body (120) and lens (110) assembled, completely isolating this far end; it provides for transverse fins (151), internally in the upper region for better fixation with the lens (110) and to avoid its deformation. It also provides a channel (152) on the internal part along the entire contour in the region of its edge, which has the purpose of allocating the specific glue that will assist in its fixation process. The holes (153) are also provided for fitting the set of fixing screws (190), which will each be secured by means of their respective screwing points (121) of the body (120).

FIGS. 6A, 6B, 6C and 6D illustrate in detail the energized end cover (160), which also has compatible contour lines to fit the end of the body (120) and lens (110) assembled completely isolating this end; it provides for transverse fins (161), internally in the upper region for better fixation with the lens (110) and to avoid its deformation. It also provides a channel (162) on the internal part along the entire contour in the region of its edge, which has the purpose of allocating the specific glue that will assist in its fixation process. The holes (163) are also provided for the fitting of the set of fixing screws (190), which will be attached each through their respective points of screwing (121) of the body (120). The cable gland (170) is fixed in energized end cover (160); in FIG. 6C shows the said energized end cover (160), having a lowered region (164) where a through hole (165) is provided and through this hole (165) that passes the power cable (180), which supply the led emitter device (130); the insulation in the region of the hole (165) is made by means of the cable gland (170) element. The cable gland (170) used must have compatible characteristics to guarantee the proposal of the lamp (100), which is to withstand extreme temperatures, to have high tightness, etc; currently there are cable gland elements with IP69 on the market, compatible with our proposal, so models similar to these or higher should be used.

FIG. 7A illustrates the led emitter device (130) with the cable gland (170) and the power cable (180), and FIGS. 7B and 7C illustrate the set comprising the energized end cover (160) with the cable gland (170) and the led emitter device (130). In this assembly the led emitter device (130) is inserted in the recess (123) internally to the body (120), this recess (123) already has dimensioning adjusted to hold the led emitter device (130), however, it can still be fixed or secured by means of clamp or even glued, to further improve its fixation. Said led emitting device (130) is completely resin, in order to guarantee complete watertightness to the electronic components internally.

FIGS. 8 and 9 facilitate the illustration of how to assemble this part of the lamp (100) which comprises the led emitter device (130) disposed internally to the body (120), the energized end cover (160) and the cable gland (170). As previously described, the end covers (150 and 160) are attached by a set of screws (190) and glued using specific glue.

With this configuration, presented in this specification, it is possible to guarantee the characteristics proposed in this lamp (100), giving it improvements, as already described, especially in its functionality, compared to all those in the prior art.

1. Structural arrangement applied to a lamp for use in extreme low and high temperature environments comprising a lens (110), attached to a body (120), having a led emitter device (130) internally, connected to a set of led tapes (140) arranged on said body (120), and having end covers (150 and 160), here called simple end cover (150) and energized end cover (160), also attached and glued to the body (120) and joined and fixed with the lens (110), wherein the body (120) provides screwing points (121), preferably in each of the four corners, and has channels (122) in the region of its base, for clamping the luminaire (100) at the place where it will be arranged to perform its function, and provide a recess (123) with dimensions sufficiently compatible to allocate and be properly fixed the led emitter device (130), and in the region of the upper longitudinal edges the channels (124) with compatible dimensions for the allocation of the specific glue and the fitting of the longitudinal edge (111) of the lens (110), so that the region is totally isolated and watertight; and the simple end cover (150) provides transverse fins (151), in the upper region for the best fixation with the lens (110) and has a channel (152) in the internal part along the entire contour in the region of its edge, which has the purpose of allocating the specific glue that will assist in its fixation process to the body (120) and the lens (110); and also has the holes (153) for fitting the set of fixing screws (190), which they will be attached each one by means of their respective screwing points (121) of the body (120); and the energized end cover (160) has transverse fins (161), internally in the upper region for better fixation with the lens (110) and to avoid its deformation, and also have a channel (162) in the internal part along the entire contour in the region of its edge, which has the purpose of allocating the specific glue that will assist in its fixing process, holes (163) are also provided for the fitting of the set of fixing screws (190), which will be attached each by means of their respective screwing points (121) of the body (120), and for having a recessed region (164) where a through hole (165) is provided and through this hole (165) pass the power cable (180), which feeding the led emitter device (130); and the insulation in the hole region (165) is done by means of a cable gland (170), with compatible characteristics for extreme temperatures and high tightness; and for providing specific film (200) consisting of a security film (SF) with a range of 2000 to 4000 microns, joined or glued, overlapping, with a translucent vinyl (TV), flexible, with a specific color of interest, inserted in said led luminaire, so as to be disposed between the led tape (140) and the lens (110) of the led luminaire (100), assembled so as to acquire the contour of said lens (110), covering its entire region, from the inside and being fixed through the regions of the edge (111) of the lens (110).

2. Structural arrangement applied to a lamp according to claim 1 characterized by the use of a clamp, to ensure a better fixation of the led emitter device in the recess of the body.

3. Structural arrangement applied to a lamp according to claim 1 characterized by the led emitter device being completely made of resin.

4. Structural arrangement applied to a lamp according to claim 1 characterized by the translucent vinyl (TV) being in a primary color: green, blue or yellow.

5. Structural arrangement applied to a lamp according to claim 1, where the translucent vinyl (TV) is a color resulting from one or more primary colors.
